(19) United States
(12) Patent Application Publication
(10) Pub. No.: US 2008/0240186 A1
(43) Pub. Date: Oct. 2, 2008

(54) Polygonal cross-section laser rod for low-cost flashlamp-pumped laser

(76) Inventor: Xinbing Liu, Acton, MA (US)

Correspondence Address: RATNERPRESTIA, P.O. BOX 980, VALLEY FORGE, PA, 19482, US

(21) Appl. No.: 11/729,586

(22) Filed: Mar. 29, 2007

(51) Int. Cl. H01S 3/17

(52) U.S. Cl. 372/40; 65/61

(57) ABSTRACT

A laser rod and methods of manufacturing a plurality of laser rods such that each laser rod has two polished end surfaces and an optical axis that extends between the two polished end surfaces. The laser rod includes a gain material component that has a substantially prismatic shape. The gain material component includes: a first end surface that is substantially optically smooth; a second end surface that is substantially optically smooth; at least three flat side surfaces; and an optical axis, which is substantially parallel to the flat side surfaces. The optical axis intersects the first end surface at a first incidence angle and it intersects the second end surface at a second incidence angle.

### FIELD OF THE INVENTION

The present invention concerns laser rods and manufacturing methods that may reduce the number of laser rod manufacturing steps. In particular, the methods of the present invention may save processing time and reduce the cost of the laser rods.

### BACKGROUND OF THE INVENTION

There are numerous uses for lasers. However, in some of these applications, the cost of the laser may be a factor in determining whether to use a laser or another component. One way to lower the cost of a laser is to use a flashlamp as the pump source for a solid-state laser rod; however, the laser rod may still prove prohibitively expensive for some applications. For example, a flashlamp-pumped Er:YAG laser having a peak wavelength of 2.94 μm may be used as laser lancet for a blood glucose monitor product. An important issue for such a laser lancet is the manufacturing cost of the laser, because the blood glucose monitor is expected to be mass-produced and sell for low prices to patients.

Traditionally, solid-state laser rods, such as those used in flashlamp-pumped lasers are round, i.e. they have a circular cross-section. In one method for producing these circular laser rods, square precursor rods are diced from slabs of laser materials that have a thickness slightly larger than the desired diameter of the laser rods. The circular cross-section of these laser rods may then be formed by grinding the square cross-section precursor rods. Alternatively, the laser rods may be formed by using a coring machine to cut circular rods from a bulk crystal. Both of these methods may be time consuming, which increases the manufacturing cost. The round rods may then be assembled in a bundle for end grinding and polishing. Their ends are ground and polished until they are optically smooth.

Exemplary embodiments of the present invention detail an alternative laser rod manufacturing method specifically aimed at reducing the rod manufacturing steps, thus saving processing time and reducing cost.

### SUMMARY OF THE INVENTION

An exemplary embodiment of the present invention is a laser rod, including a gain material component that has a substantially prismatic shape. The gain material component includes: a first end surface that is substantially optically smooth; a second end surface that is substantially optically smooth; at least three flat side surfaces; and an optical axis, which is substantially parallel to the flat side surfaces. The optical axis intersects the first end surface at a first incidence angle and it intersects the second end surface at a second incidence angle.

Another exemplary embodiment of the present invention is a method of manufacturing a plurality of laser rods such that each laser rod has two polished end surfaces and an optical axis that extends between the two polished end surfaces. A slab of gain material that includes a top surface and a bottom surface is provided. The top surface and the bottom surface of the slab of gain material are polished to be substantially optically smooth. The slab of gain material is diced along a first set of substantially parallel and equally spaced planes. These substantially parallel and equally spaced planes are substantially parallel to the optical axes of the laser rods. The slab of gain material is then diced along a second set of substantially parallel and equally spaced planes to form the plurality of laser rods. The second set of substantially parallel and equally spaced planes forms a predetermined angle with the first set of substantially parallel and equally spaced planes. This set of substantially parallel and equally spaced planes is also substantially parallel to the optical axes of the laser rods.

A further exemplary embodiment of the present invention is a method of manufacturing a plurality of laser rods such that each laser rod has two polished end surfaces and an optical axis that extends between the two polished end surfaces. A slab of gain material that includes a top surface and a bottom surface is provided. The top surface and the bottom surface of the slab of gain material are polished to be substantially optically smooth. The slab of gain material is diced along a first set of substantially parallel and equally spaced planes. These substantially parallel and equally spaced planes are substantially parallel to the optical axes of the laser rods. The slab of gain material is diced along a second set of substantially parallel and equally spaced planes. The second set of substantially parallel and equally spaced planes is substantially parallel to the optical axes of the laser rods and intersects the first set of substantially parallel and equally spaced planes so as to define a plurality of side edges. The slab of gain material is then diced along a third set of substantially parallel and equally spaced planes to form the plurality of laser rods. These substantially parallel and equally spaced planes are spaced and arranged to intersect the first and second sets of substantially parallel and equally spaced planes at the plurality of side edges.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawing are the following figures:

FIG. 1A is a side plan drawing illustrating an exemplary laser rod according to the present invention.

FIGS. 1B, 1C, 1D, and 1E are end plan drawings illustrating alternative exemplary end views of the exemplary laser rod of FIG. 1A.

FIG. 2 is a flowchart illustrating an exemplary method of manufacturing a laser rod according to the present invention.

FIGS. 3A, 3D, and 3E are side perspective drawings illustrating steps of the exemplary method of manufacturing a laser rod of FIG. 2.

FIGS. 3B and 3C are side plan drawings illustrating steps of the exemplary method of manufacturing a laser rod of FIG. 2.

FIGS. 4A, 4B and 4C are top plan drawings illustrating exemplary additional steps that may be used with the exemplary methods of FIGS. 2 or 5 to form patterned reflectors on the resulting laser rods.

FIG. 5 is a flowchart illustrating an alternative exemplary method of manufacturing a laser rod according to the present invention.

FIGS. 6A and 6B are side plan drawings illustrating alternative exemplary laser rods according to the present invention.

### DETAILED DESCRIPTION OF THE INVENTION

Exemplary embodiments of the present invention involve exemplary laser rod manufacturing processes that reduce manufacturing time, and the resulting laser rods. These exemplary techniques allow for the fabrication of reduced cost laser rods.

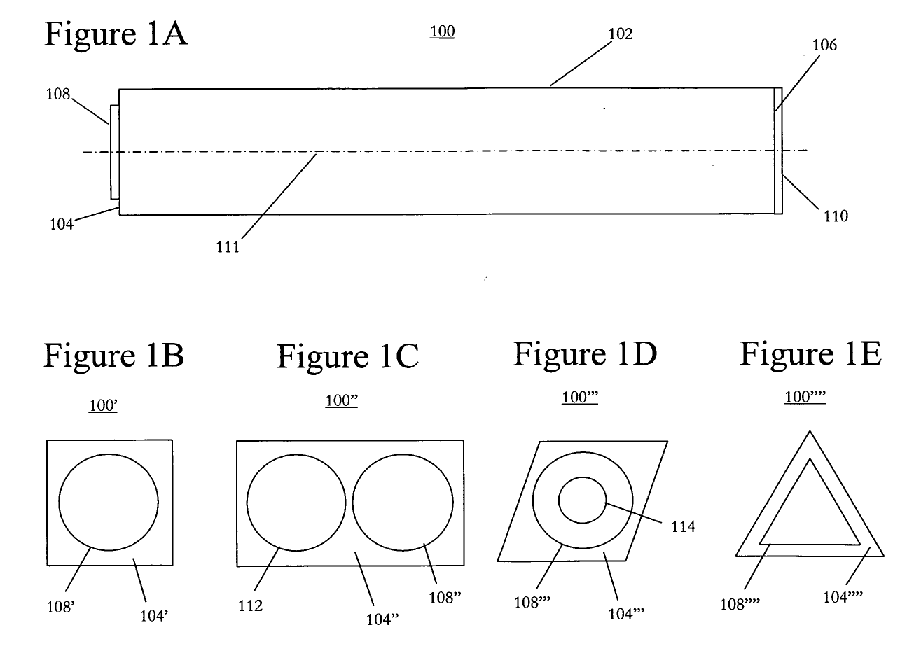

FIGS. 1A-E illustrate an exemplary embodiment of the present invention. This exemplary embodiment is a laser rod for use in a low-cost pulsed laser system. FIG. 1A illustrates a side view of exemplary laser rod 100, which includes: gain material component 102; patterned reflector 108; and unpatterned reflector 110. It is noted that, although exemplary laser rod 100 is shown with integral reflectors 108 and 110, one, or both, of these integral reflectors may be omitted and an external reflector may be used at the corresponding end(s) of the laser cavity. Alternatively, if an external reflector is used, the integral reflector at that end of the laser rod may be replaced by an antireflection (AR) coating layer (not shown).

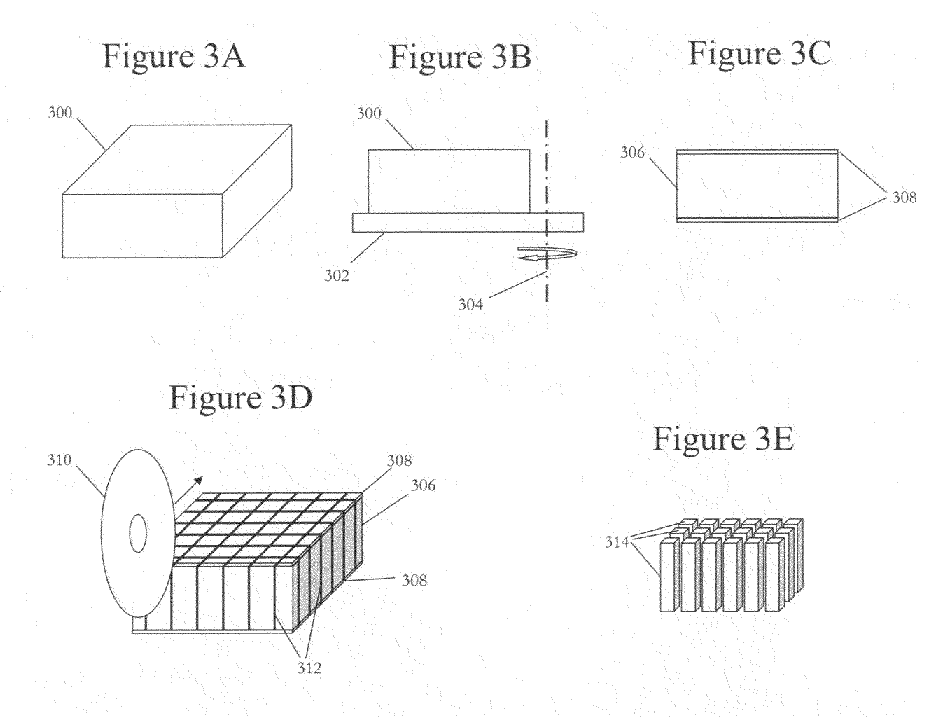

Gain material component 102 has a right prism shape with at least three flat side surfaces, which are parallel to optical axis 111. Laser rods 100′, 100″, and 100′″ shown in FIGS. 1B, 1C, and 1D, respectively, illustrate three different exemplary cross-sections that have four flat side surfaces and laser rod 100″″ shown in FIG. 1E illustrates one exemplary cross-section that has three flat side surfaces. These examples are merely illustrative and are not intended to be limiting, i.e. other polygonal cross-sections may be used as well. It may be desirable, however, that gain material component 102 have a cross-section that is either a parallelogram or a triangle. This is because parallelogram cross-section right prisms may be diced from a slab of gain material by making two sets of equally spaced, parallel cuts across the slab (as shown in FIG. 3D) and triangle cross-section right prisms may be diced from a slab of gain material by making three sets of equally spaced, parallel cuts across the slab that intersect at common vertices. Additionally, it may be desirable for the cross-sectional shape of gain material component 102 to be equilateral, as shown in exemplary laser rods 100′, 100′″, and 100″″ in FIGS. 1B, 1D, and 1E, respectively.

As gain material component 102 has a right prismatic shape, first end surface 104 and second end surface 106 are substantially parallel to each other and substantially perpendicular to the flat side surfaces.

Gain material component 102 may be a crystalline gain material, a ceramic gain material, or a glass gain material. It is noted, however, that ceramic or glass gain materials may be significantly less expensive than crystalline gain materials. For example, an Er:YAG laser fabricated using ceramic Er:YAG gain material instead of traditional single-crystal Er:YAG laser material may have significantly lower cost. Also, as ceramic gain materials, such as Er:YAG, may be readily made into slabs of any desired thickness (e.g., ˜50 mm for a blood glucose monitor application), ceramic gain materials may be particularly desirable for mass production of low-cost laser rods.

First end surface 104 and second end surface 106 are desirably substantially optically smooth. It is not necessary for the flat side surfaces to be optically smooth, particularly if one, or both, ends of laser rod 100 have a patterned reflector to control the transverse modes of the laser such that supported transverse mode(s) have minimal interaction with the flat side surfaces. If neither end of laser rod 100 has a patterned reflector formed on it, the unpolished (and non-circular) side surfaces may lead to some additional loss and/or complex multiple transverse mode behavior; however, in many applications these issues may not be as important as a simplified method of mass production.

For low-cost lasers, it may be desirable for the laser rod to have reflective coatings formed directly on the ends to form the laser cavity directly. It may also be desirable for the reflective coating on one end to be highly reflecting and the reflective coating on the other end to be partially reflecting to serve as the output coupler. With rectangular cross-section laser rods, such as shown in exemplary laser rods 100′ and 100″ in FIGS. 1B and 1C, if the entirety of end surfaces 104 and 106 are coated, an output beam having rectangular geometry and mode structure is generated. Similarly, non-rectangular parallelogram cross-section and triangular cross-section laser rods (such as laser rods 100′″ and 100′″, respectively) may generate output beams with unusual transverse mode structures and geometries. These various non-circular geometries may or may not prove desirable or advantageous. If they are desirable and advantageous for a particular application, then no further modification is necessary; however, if they are not desirable or advantageous to an application, patterned coatings may be applied to one, or both, end surface(s) of the prismatic shaped rod to change the shape of the output beam. These coatings may define the lasing region within gain material 102 even though the entire rod is pumped by a flashlamp or other source, hence a patterned reflector formed by such a coating (e.g., patterned reflectors 108′ in FIG. 1B, 108″ and 112 in FIG. 1C, 108′″ in FIG. 1D, and 108″″ in FIG. 1E) defines the output laser beam shape and/or transverse mode structure of the laser. It is noted that patterned reflector 108 needs to be applied to only one end surface of gain material 102 to control the output beam shape and mode structure of the laser. The other end surface may be coated with unpatterned reflector 110, further simplifying fabrication.

It may be desirable for patterned reflector 108 to be centered on end surface 104 as shown in the exemplary laser rods of FIGS. 1B, 1D, and 1E; however this is not necessary.

The reflective coating used to form either patterned reflector 108 or unpatterned reflector 110 may be a multi-layer dielectric mirror or it may be a reflective metal coating. If either of the reflective coatings is a multi-layer dielectric mirror this coating may desirably be adapted to preferentially reflect radiation having a predetermined wavelength. This may allow for selection of specific transitions in the gain material and/or single longitudinal mode operation.

Alternatively, a laser rod may be adapted to generate a plurality of output laser beams, such as laser rod 100″ in FIG. 1C. The multi-layer dielectric mirror is patterned to include separate patterned sections 108″ and 112 corresponding to two separate output laser beams. These patterned sections define the cross-sectional shape and position of the corresponding output laser beams. Additionally, section 108″ and section 112 may be adapted to preferentially reflect radiation having different peak wavelengths, thus defining the peak wavelengths of the corresponding output laser beams.

It is noted that AR coatings formed on end surfaces 104 and 106 may be patterned and/or tuned to preferentially transmit specific wavelengths, thereby controlling the output beams of exemplary lasers with external mirrors, as well.

FIGS. 1B-E illustrate several examples of different patterned reflectors (or AR coatings) and different laser rod cross-sections. FIG. 1B illustrates exemplary laser rod 100′ with circular reflector 108′, which is centered on square end surface 104′. FIG. 1C illustrates exemplary laser rod 100″ with circular reflectors 108″ and 112, which are arranged side-by-side on rectangular end surface 104″. FIG. 1D illustrates exemplary laser rod 100′″ with annular reflector 108′″, which is centered on rhomboid end surface 104′″. Section 114 may be an area of bare end surface 108′″ inside of annular reflector 108′″, an AR coated area, or it may be an additional patterned reflector having a different reflectance and/or different spectral properties compared to annular reflector 108′″. FIG. 1E illustrates exemplary laser rod 100″″ with triangular reflector 108″″, which is centered on triangular end surface 104″″.

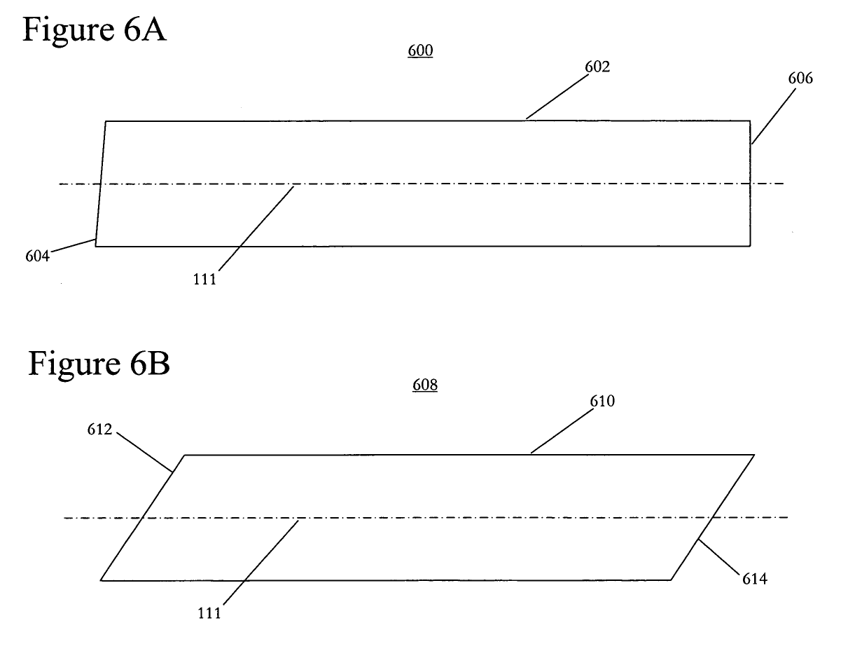

FIGS. 6A and 6B illustrate alternative exemplary laser rods 600 and 608, respectively. Gain material component 602 includes end surface 604 which is formed at a slight angle, such as about 2°, to end surface 606. Thus, the angle of incidence of optical axis 111 on end surface 604 is different than the angle of incidence of optical axis 111 on end surface 606. Exemplary laser rod 600 may desirably be used with an external reflector on the end of end surface 604. The angle of end surface 604 reduces coupling of light reflected from this surface into the laser modes. Exemplary laser rod 600 may include a reflective coating on end surface 606 and an AR coating on end surface 604.

FIG. 6B illustrates gain material component 610 in which optical axis 111 has a non-zero angle of incidence with both end surfaces 612 and 614, although these surfaces may be parallel, as shown in FIG. 6B. One possible angle of incidence between optical axis and end surfaces 612 and 614 that may be desirable is Brewster's angle. Exemplary laser rod 608 may desirably be used with an external reflector on each end.

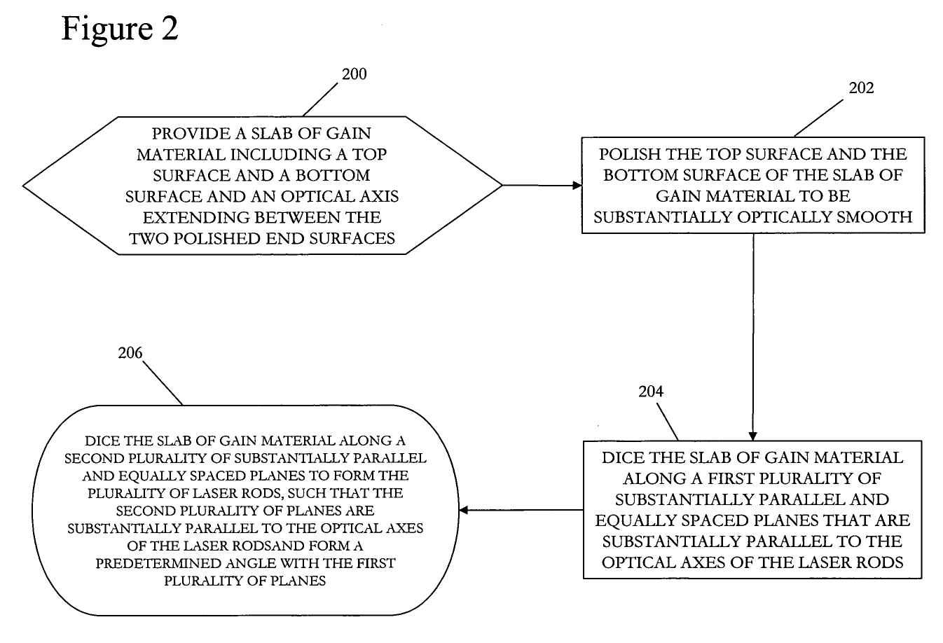

FIG. 2 illustrates an exemplary method of manufacturing a plurality of laser rods that each has two polished end surfaces and an optical axis extending between the two polished end surfaces. FIGS. 3A-E illustrate the process of the laser rods at various steps of this exemplary method.

A slab of gain material including a top surface and a bottom surface is provided, step 200. FIG. 3A illustrates slab 300. The thickness of slab 300 is a little thicker than the desired length of the final rods to take into account the expected thickness loss during grinding and polishing of the ends of the laser rods.

The top surface and the bottom surface of slab 300 of gain material are polished to be substantially optically smooth, step 202. An exemplary polishing technique is shown in FIG. 3B in which polishing wheel 302 is rotated about axis 304 as each of the top and bottom surfaces of slab 300 are polished in turn. Depending in the initial smoothness, and parallelism, of the top and bottom surfaces of slab 300, these surfaces may be ground to achieve somewhat smooth surfaces before the polishing begins. During this step care is taken so that the resulting polished surfaces are at the desired angle to the optical axes of the laser rods. In many cases it may be desirable for the surfaces to be substantially parallel to each other. In these cases, minor problems with parallelism of the initial top and bottom surfaces of slab 300 may be corrected in this step.

A reflective coating or an AR coating may be formed on the polished top and/or bottom surfaces of the polished slab of gain material at this point. Alternatively, the coatings may be applied after individual laser rods are diced from the slab. Applying coatings to the polished slab, however, may simplify handling of individual pieces. The coatings may be a multilayer dielectric structure or, in the case of a reflective coating, the coating may be a metal film.

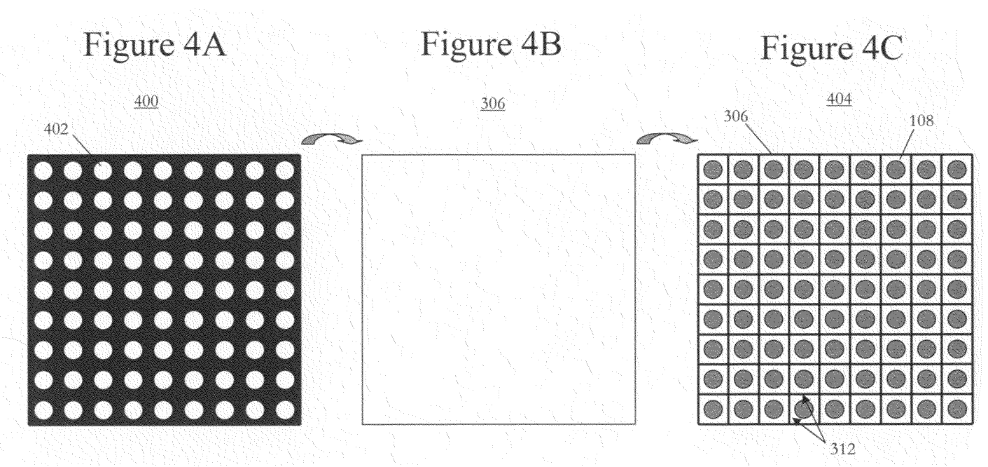

The coating layer(s) may be patterned to form a plurality of reflectors, or output couplers, that are sized and arranged such that each reflector, or output coupler, defines a cross-sectional shape of the output laser beam of one of the plurality of laser rods. An exemplary process for forming patterned coatings on a polished slab is illustrated in the diagrams in FIGS. 4A-C. FIG. 4A illustrates mask 400, which has a rectangular array of circular openings 402 corresponding to the desired laser beam shape. This mask may be placed on top of polished slab 306 (shown in FIG. 4B), and the coating layer may be applied to the slab surface through openings 402 of mask 400 to form patterned reflectors 108 (or patterned AR coating output couplers). It is noted that mask 400 may be a photolithographic mask and standard photolithographic techniques may be used to pattern the coating as well. The coating defines the output laser beam shape and, hence, may define the lasing region within each laser rod even though the entire rod is pumped during operation. Cut lines 312 are shown on the surface of coated slab 404 in FIG. 4C to illustrate how the patterned coating for all of the laser rods to be diced from the slab are formed at once by this technique.

As shown in FIG. 3C, protective coating 308 may be formed on the polished top and bottom surfaces of polished slab 306 of gain material. Protective coating 308, which may be formed of a polymer, wax, or resist, serves to protect the optically smooth surfaces of polished slab 306 during the dicing procedure that follows.

Returning to FIG. 2, the slab of gain material is diced along a first plurality of substantially parallel and equally spaced planes, which are substantially parallel to the optical axes of the plurality of laser rods, step 204. FIG. 3D illustrates one exemplary technique of dicing polished slab 306 of gain material. In this exemplary technique, polished slab 306 is cross cut using dicing saw 310 along cutting lines 312. Alternatively, other dicing techniques may be used, such as using a wire saw or, if a crystalline gain material is used, cleaving the polished slab.

Polished slab 306 of gain material is next diced along a second plurality of substantially parallel and equally spaced planes, step 206, to form the plurality of laser rods 314 as shown in FIG. 3E. The second plurality of planes is also substantially parallel to the optical axes of the plurality of laser rods and forms a predetermined angle with the first plurality of planes. In the example of FIG. 3D, these two pluralities of planes (i.e. cut lines 312) are illustrated as perpendicular to each other and to the top and bottom surfaces of polished slab 306 of gain material and as having equal spacing so that the resulting laser rods are square right prisms. It is noted that these two pluralities of planes may have different spacings and, thus, form laser rods with non-square rectangular cross-sections, such as exemplary laser rod 100″ shown in FIG. 1C. Additionally, other angles between the two pluralities of substantially parallel planes may be used to form laser rods with non-rectangular parallelogram cross-sections, such as exemplary laser rod 100′″ shown in FIG. 1D.

If a protective coating was applied in step 202, this protective coating may be removed from the two polished end surfaces of each laser rod following dicing.

Reflective or AR coatings may be applied to individual rods after they are diced from the slab. It is noted that it may be desirable to apply metal coatings after the protective layer is removed rather than before dicing because of the delicate nature of metal thin films.

Because the laser rods are diced directly from polished slabs, no extra time-consuming individual grinding of each rod into circular cross-section is needed. Also using this process it may be possible to produce laser rods having smaller cross-sections than are practical for circular cross-section laser rods. This is because, when round rods are made from bulk material either by grinding or coring, practical tooling and handling difficulties typically limit the minimum diameter of the laser rod that is produced for mass manufacturing. This minimum diameter limit is typically 1.5mm or larger. With cross cutting of slabs, smaller sized laser rods may be easily diced from the slab. Smaller cross-section laser rods may desirably produce better laser output beam quality.

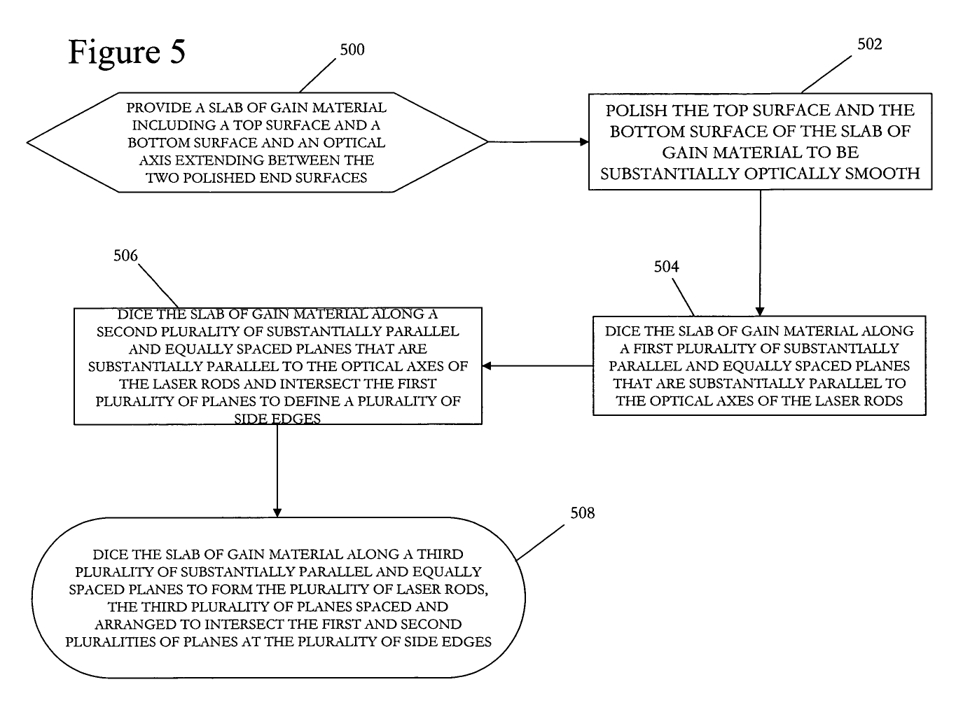

FIG. 5 illustrates an alternative method of manufacturing a plurality of laser rods that each has two polished end surfaces and an optical axis extending between the two polished end surfaces. This exemplary method, however, produces laser rods that have triangular cross-sections. As in the exemplary method of FIG. 2, a slab of gain material, including a top surface and a bottom surface, is provided, step 500. The top and bottom surfaces of the slab of gain material are polished to be substantially optically smooth, step 502. The polished slab is diced along a first plurality of substantially parallel and equally spaced planes that are substantially parallel to the optical axes of the plurality of laser rods, step 504.

The polished slab is then diced along a second plurality of substantially parallel and equally spaced planes, step 506. This second plurality of substantially parallel planes is also substantially parallel to the optical axes of the plurality of laser rods and they intersect the first plurality of planes, defining a plurality of side edges of the laser rods. The polished slab is dice along a third plurality of substantially parallel and equally spaced planes, step 508. This third plurality of planes is spaced and arranged to intersect the first and second pluralities of planes at the plurality of side edges to form laser rods that have triangular cross-sections.

As in the exemplary method of FIG. 2, additional steps may be included in the exemplary method of FIG. 5, such as adding a protective coating layer, or reflective and/or AR coatings to the polished surfaces of the slab.

The present invention includes a number of exemplary embodiments of exemplary laser rods and methods of manufacturing laser rods. Although the invention is illustrated and described herein with reference to specific embodiments, it is not intended to be limited to the details shown. Rather, various modifications may be made in the details within the scope and range of equivalents of the claims and without departing from the invention. In particular, one skilled in the art may understand that many features of the various specifically illustrated embodiments may be mixed to form additional exemplary laser rods also embodied by the present invention.

What is claimed:

1. A laser rod, comprising a gain material component having a substantially prismatic shape, the gain material component including:
a first end surface that is substantially optically smooth;
a second end surface that is substantially optically smooth;
at least three flat side surfaces; and
an optical axis substantially parallel to the at least three flat side surfaces, the optical axis intersects the first end surface at a first incidence angle and intersects the second end surface at a second incidence angle.

2. A laser rod according to claim 1, wherein the gain material component is formed of one of a crystalline gain material; a ceramic gain material; or a glass gain material.

3. A laser rod according to claim 1, wherein the cross-sectional shape of the gain material component in a plane parallel to the first end surface is one of a non-right parallelogram, a rectangle, a square, or a triangle.

4. A laser rod according to claim 1, wherein a difference between the first incidence angle and the second incidence angle is less than or equal to about 20.

5. A laser rod according to claim 1, wherein at least one of the first incidence angle or the second incidence is approximately equal to one of Brewster's angle or normal incidence.

6. A laser rod according to claim 1, further comprising a reflective coating formed on the first end surface of the gain material component;
wherein the optical axis is substantially normal to the first end surface of the gain material component.

7. A laser rod according to claim 6, wherein the reflective coating is patterned to define a cross-sectional shape of an output laser beam of the laser rod.

8. A laser rod according to claim 6, wherein the reflective coating has a circular shape and is substantially centered on the first end surface of the gain material component.

9. A laser rod according to claim 6, wherein the reflective coating is a multi-layer dielectric mirror adapted to preferentially reflect radiation having a predetermined spectrum.

10. A laser rod according to claim 91 wherein:
the laser rod is adapted to generate a plurality of output laser beams, each output laser beam having one of a plurality of peak wavelengths of the gain material;
the multi-layer dielectric mirror is patterned to include a plurality of separate sections corresponding to the plurality of output laser beams to define a cross-sectional shape and position of the corresponding output laser beam; and
each section of the multi-layer dielectric mirror is adapted to preferentially reflect radiation having the peak wavelength of the corresponding output laser beam.

11. A laser rod according to claim 6, wherein the reflective coating is formed of a metal.

12. A laser rod according to claim 6, further comprising a reflective coating formed on the second end surface of the gain material component;
wherein the second end surface of the gain material component is substantially parallel to the first end surface of the gain material component.

13. A laser rod according to claim 6, further comprising an antireflection coating formed on the second end surface of the gain material component.

14. A laser rod according to claim 1, further comprising an antireflection (AR) coating formed on the first end surface of the gain material component, the AR coating adapted to preferentially transmit radiation having a predetermined spectrum.

15. A laser rod according to claim 14, wherein:
the laser rod is adapted to generate a plurality of output laser beams, each output laser beam having one of a plurality of peak wavelengths of the gain material;
the AR coating is patterned to include a plurality of separate sections corresponding to the plurality of output laser beams to define a cross-sectional shape and position of the corresponding output laser beam; and
each section of the AR coating is adapted to preferentially transmit radiation having the peak wavelength of the corresponding output laser beam.

16. A laser rod according to claim 14, further comprising an AR coating formed on the second end surface of the gain material component.

17. A method of manufacturing a plurality of laser rods, each laser rod having two polished end surfaces and an optical axis extending between the two polished end surfaces, the method comprising the steps of:
a) providing a slab of gain material including a top surface and a bottom surface;
b) polishing the top surface of the slab of gain material to be substantially optically smooth;
c) polishing the bottom surface of the slab of gain material to be substantially optically smooth;
d) dicing the slab of gain material along a first plurality of substantially parallel and equally spaced planes, the first plurality of substantially parallel and equally spaced planes being substantially parallel to the optical axes of the plurality of laser rods; and
e) dicing the slab of gain material along a second plurality of substantially parallel and equally spaced planes to form the plurality of laser rods, the second plurality of substantially parallel and equally spaced planes:
forming a predetermined angle with the first plurality of substantially parallel and equally spaced planes; and
being substantially parallel to the optical axes of the plurality of laser rods.

18. A method according to claim 17, wherein:
step (b) further includes forming a protective coating on the polished top surface of the slab of gain material;
step (c) further includes forming a protective coating on the polished bottom surface of the slab of gain material; and
the method further comprises the step of;
f) removing the protective coating from the two substantially parallel, polished end surfaces of each laser rod formed in step (e).

19. A method according to claim 17, wherein step (b) further includes forming a reflective coating on the polished top surface of the slab of gain material.

20. A method according to claim 19, wherein step (c) further includes forming a reflective coating on the polished bottom surface of the slab of gain material.

21. A method according to claim 19, wherein the reflective coating formed in step (b) is patterned to form a plurality of reflectors, the plurality of reflectors sized and arranged such that each reflector defines a cross-sectional shape of an output laser beam of one of the plurality of laser rods.

22. A method according to claim 17, wherein step (b) further includes forming an antireflection (AR) coating on the polished top surface of the slab of gain material.

23. A method according to claim 22, wherein step (c) further includes forming an AR coating on the polished bottom surface of the slab of gain material.

24. A method according to claim 22, wherein the AR coating formed in step (b) is patterned to form a plurality of output couplers, the plurality of output couplers sized and arranged such that each output coupler defines a cross-sectional shape of an output laser beam of one of the plurality of laser rods.

25. A method according to claim 17, wherein:
dicing the slab of gain material in step (d) includes one of:
cutting the slab of gain material along the first plurality of substantially parallel and equally spaced planes; or
cleaving the slab of gain material along the first plurality of substantially parallel and equally spaced planes; and
dicing the slab of gain material in step (e) includes one of:
cutting the slab of gain material along the second plurality of substantially parallel and equally spaced planes; or
cleaving the slab of gain material along the second plurality of substantially parallel and equally spaced planes.

26. A method according to claim 17, wherein a distance between consecutive pairs of the second plurality of substantially parallel and equally spaced planes is approximately equal to a distance between consecutive pairs of the first plurality of substantially parallel and equally spaced planes.

27. A method according to claim 17, wherein the predetermined angle between the first plurality of substantially parallel and equally spaced planes and the second plurality of substantially parallel and equally spaced planes is approximately 900.

28. A method of manufacturing a plurality of laser rods, each laser rod having two polished end surfaces and an optical axis extending between the two polished end surfaces, the method comprising the steps of:
a) providing a slab of gain material including a top surface and a bottom surface substantially parallel to the top surface;
b) polishing the top surface of the slab of gain material to be substantially optically smooth;
c) polishing the bottom surface of the slab of gain material to be substantially optically smooth;
d) dicing the slab of gain material along a first plurality of substantially parallel and equally spaced planes, the first plurality of substantially parallel and equally spaced planes being substantially parallel to the optical axes of the plurality of laser rods;
e) dicing the slab of gain material along a second plurality of substantially parallel and equally spaced planes, the second plurality of substantially parallel and equally spaced planes:
being substantially parallel to the optical axes of the plurality of laser rods; and
intersecting the first plurality of substantially parallel and equally spaced planes to define a plurality of side edges; and
f) dicing the slab of gain material along a third plurality of substantially parallel and equally spaced planes to form the plurality of laser rods, the third plurality of substantially parallel and equally spaced planes spaced and arranged to intersect the first plurality of substantially parallel and equally spaced planes and the second plurality of substantially parallel and equally spaced planes at the plurality of side edges.
